(19) United States
(12) Patent Application Publication
(10) Pub. No.: US 2014/0278825 A1
(43) Pub. Date: Sep. 18, 2014

(54) Dynamic Database Calculations Without Saving Modified Data

(71) Applicant: Manish Joshi, Bangalore (IN)

(72) Inventor: Manish Joshi, Bangalore (IN)

(73) Assignee: SAP AG, Walldorf (DE)

(21) Appl. No.: 13/796,145

(22) Filed: Mar. 12, 2013

(51) Int. Cl. G06Q 10/06

(52) U.S. Cl. CPC G06Q 10/06393
USPC 705/7.39

(57) ABSTRACT

A system and method include receiving data corresponding to a proposed action in an application coupled to an application database that stores data corresponding to the application, merging data corresponding to previously stored application actions with the data corresponding to the proposed action to create a replicated image on an in memory database, and updating a key performance indicator based on the replicated image without storing the data corresponding to the proposed action in the application database.

### BACKGROUND

Many applications track complex real life situations, such as supply chain management. The applications may track many aspects of the supply chain, from ordering materials to manufacture goods to tracking orders and forecasts for the goods. Taking an action can both solve a problem and create other problems. The applications may be tied to a database that can be used to calculate key performance indicators (KPIs).

A KPI is a type of performance measurement that may be used evaluate the success of an activity. It may be defined in terms of making progress toward goals, or even the repeated achievement of an operational goal. KPIs may be defined and used differently by different areas, such as finance, manufacturing, sales, etc. Data stored in a database may be used to generate the KPIs for each area. Actions taken can modify that data, and hence result in changes in the KPIs.

### SUMMARY

A system and method include receiving data corresponding to a proposed action in an application coupled to an application database that stores data corresponding to the application, merging data corresponding to previously stored application actions with the data corresponding to the proposed action to create a replicated image on an in memory database, and updating a key performance indicator based on the replicated image without storing the data corresponding to the proposed action in the application database.

A system includes a simulation manager to receive data corresponding to a proposed action in an application coupled to an application database that stores data corresponding to the application. A replication agent merges data corresponding to previously stored application actions with the data corresponding to the proposed action to create a replicated image on an in memory database. An analytics engine is coupled to semiconductor based database storage to update a key performance indicator based on the replicated image without storing the data corresponding to the proposed action in the application database.

### BRIEF DESCRIPTION OF THE DRAWINGS

FIGS. 1A and 1B are a representation of a screen shot to simulate actions and update key performance indicators without saving the updates to an application database according to an example embodiment.

FIG. 2 is system architecture block diagram of a system to simulate actions and update key performance indicators without saving the updates to an application database according to an example embodiment.

FIG. 3 is a flowchart illustrating a method of simulating actions and updating key performance indicators without saving the updates to an application database according to an example embodiment.

FIG. 4 is a block diagram of an example computer system for implementing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Successful management of a supply chain can be dependent upon seeing the next problem coming down the road. Each action taken while managing the supply chain may have resulting operational and financial impact that affects both costs and revenues. Planners can lose productive time contemplating the effects of potential actions, and can also take actions that are not productive.

When key performance indicators (KPIs) are generated at an application level, limited capabilities to drill down on data are usually provided. In one example embodiment, the generation of KPIs is moved to an underlying database, providing a much more robust planning ability. Actions may be proposed at the application level to observe the effects on the KPIs. Prior to committing to and saving the actions, data corresponding to the proposed actions is replicated in the underlying database without having to commit to and save the actions. The replicated data corresponding to the proposed actions is used to provide real time or near real time analytics resulting in detailed KPI data. The data base may be an in-memory database, providing for much faster analytics. The KPI data generated from the replicated data may be presented to the user on the same user display with the proposed actions, allowing the user to simulate proposed actions and see the effect of such proposed actions without committing to them.

FIGS. 1A and 1B are a screen shot representation of a user interface 100 that includes an interactive planning application interface 110 to an application running on a computer system and a side panel 115 that in this embodiment shows KPI information generated from information in a database utilized by the application. In one example embodiment, the application is a product planning application for management of a supply chain in a business. One example is SAP Advanced Planning and Optimization, an enterprise-wide strategic platform for all supply chain planning needs. The example application may include production planning and detailed scheduling. Multi-level production planning with existing and customer developed heuristics and optimization may be included along with manual planning with flexible transactions. Supply network planning and capacity leveling may be used on heuristics and optimization.

The example application may also include advanced safety stock planning, distribution planning, transport load building and vendor managed inventory. The example application may further include global available to promise functionality, including online order promising with basic and advanced methods, and backorder promising. The example application allows users to synchronize supply with demand in a global supply chain by balancing push and pull network planning processes and by handing replenishment and production based on actual demand. Advanced planning optimization is tightly integrated into enterprise resource planning and can be leveraged by using additional supply chain management applications for supply network collaboration or inventor optimization. The example application is just one example of many different applications that may be used in further embodiments.

Application interface 110 provides a user the ability to view, modify, and create actions indicated in a detailed element view at 120. The element view lists various actions, including one or more purchase orders such as indicated at 125 which specifies a particular element, such as a part used to manufacture product to ship to a customer. The product in this example is “HK_FIN01”, and the element view is one defined by a user, labeled MR's Default View at 127. Various modifiable fields may be included for each action, such as quantity, production-firmed status, surplus/shortage, confirmed quantity, delivery dates, and other fields specifying information related to purchase orders. A create order function is also indicated at 128, allowing a user to add an order. An order actions function is indicated at 129, allowing a user to perform other actions related to existing orders, such as cancelling and expediting. The application provides a very powerful interface that results in large amounts of data being generated and stored, and analyzed.

Side panel 115 may include one or more parts, referred to as collaborative human interface parts (CHIP), which may be a small widget-type, encapsulated stateful piece of software that can be combined in a layout with other CHIPS to form a page or panel as shown. The side panel 115 is a container based layout or canvas that can be used to create an application by combining several CHIPs and arranging them. In the embodiment shown, side panel 115 contains multiple instances of KPI information related to information being viewed in the application interface 110. In the embodiment shown, a days of supply KPI is shown in a CHIP 125, a total receipts KPI is shown in CHIP 130, and a total requirements KPI is shown in CHIP 135. A further CHIP 140 is a placeholder chart representing that there are numerous possibilities of KPI charting that may be included in various embodiments. A spatial distribution chart like the one shown may be used to represent production capacity/sales volume across different locations, e.g., production plant/distribution channels.

The KPIs in prior systems were generated by the application which retrieved data from a database where actions, such as purchase orders were stored. When proposing actions, it was difficult to update the KPIs because of limited analytical capabilities of the applications. In some embodiments, an in-memory database may be used to generate the KPIs. However, such in-memory databases typically operate on information that has been stored, requiring a user to modify actions and actually commit to them so that the data is stored in the in-memory database and the analytical functions of the in-memory database can generate updated KPIs to display in the side panel 115. If the KPIs did not change as desired, the actions had to be modified again to return them to their previous state. It can quickly become very tedious to try different options to improve performance.

FIG. 2 illustrates a system architecture 200 for providing real time interactive planning simulation with dynamic updating of KPIs via database analytics. System 200 is divided into two session contexts indicated by broken lines 202 and 204. Session context 202 corresponds to an application side of the architecture, and session context 204 corresponds to an in-memory database side of the system.

A user interface layer 210 includes an application driven interactive planning user interface element 215 corresponding to interface 110, and user interface layer session manager 220 that interfaces with a supply chain management (SCM) server 225 running an advanced planning and optimizer application indicated at 230. The application 230 interacts with a classical database 235 and a live cache 240 to storage and retrieve data associated with the application. Classical database 235 may be a relational database that contains disk drive storage devices which stores much of the data associated with the application. Such databases typically have limited analytic capabilities as compared to in-memory databases due to the time involved in retrieving data for complex analytics. The live cache 140 may reduce access times for frequently or recently accessed data.

User interface layer 210 also includes a side panel element 245 corresponding to side panel 115. A user interface session manager manages the side panel element 245, and interfaces with the user interface session manager 220 to share data and track actions proposed via the interactive planning element 215. The side panel element 245 is also coupled to an in memory database 255 that has an analytics engine 260 to provide KPIs for display via the side panel element 245. Engine 260 is coupled to a column and row store 265 that typically comprises semiconductor memory with fast random access capabilities. By storing database data in the store 265 and providing fast access of the data to the engine 260, complex analytics may be employed to provide the KPIs.

A transaction and simulation manager is coupled to both the user interface session managers 220 and 250, and is used to track proposed actions received via the interactive planning user interface 215. The actions result in new data that has not yet been stored in the classical database 235. Two replication agents indicated at 275 in session context 202 and at 280 in session context 204 are used to replicate data from both the classical database 235 and the proposed actions into the store 265. As changes are made to simulate changed, new, and cancelled actions, a replicated database in the in-memory database context 204 is created and maintained without committing the changes in the application context 202. The engine 260 then utilizes this replicated data to perform analytics on the changed data and show the effects of proposed actions in the KPI data displayed via the side panel 204.

In one embodiment, the replication agents may utilize a load and transform replication server that is positioned as indicated at 280 for real time data replication from many different types of databases. The transaction and simulation manager 255 may trigger the replication based on a user selecting a run simulation option, such as by selecting a KPI update function based on currently displayed proposed changes to actions, referred to as a simulation session. Active data from the live cache 240 may be extracted and replicated against the simulation session. At this point, the in memory database 255 will merge active data with the data with the simulation data and generate KPIs for display.

Each action, such as increasing quantities or dates in a purchase order, may have side effects. There may be delays, additional costs, holding costs, and other effects associated with a change. System 200 facilitates simulating many changes and seeing the side effects without having to commit to and store the changes.

FIG. 3 is a flowchart illustrating a method 300 of simulating actions and changes to actions in an application and updating KPIs generated by a database without committing to the changes. At 310, modifications to actions in an application are received. At 315, an indication to trigger a simulation is received. Responsive to the trigger indication, data corresponding to the modified actions is obtained and merged with data from an application database, such as a live cache at 320 to create replicated data. The replicated data is stored in an in memory database at 325, and predetermined analytics are performed on the replicated data at 330. At 335, the analytics are used to generate updated KPI data. The updated KPI data is provided at 340 to a side panel user interface element for display to a user. In some embodiments, the KPI data is displayed as a side panel adjacent to the application data being modified to simulate changes to actions.

FIG. 4 is a block diagram of a computing device to implement one or more applications, databases, and methods, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 400 may include a processing unit 402, memory 403, removable storage 410, and non-removable storage 412. Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 400 may include or have access to a computing environment that includes input 406, output 404, and a communication connection 416. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### EXAMPLES

### Example 1

A method comprising:

receiving data corresponding to a proposed action in an application coupled to an application database that stores data corresponding to the application;

merging data corresponding to previously stored application actions with the data corresponding to the proposed action to create a replicated image on an in memory database; and

updating a key performance indicator based on the replicated image without storing the data corresponding to the proposed action in the application database.

### Example 2

The method of example 1 and further comprising displaying the updated key performance indicator.

### Example 3

The method of example 2 and further comprising storing the proposed action based on the key performance indicator.

### Example 4

The method of any of examples 1-3 wherein the proposed action corresponds to actions available via the application.

### Example 5

The method of example 4 wherein the proposed action includes changes to a previously stored action.

### Example 6

The method of any of examples 4-5 wherein the proposed action includes multiple new actions, each action having multiple parameters.

### Example 7

The method of any of examples 4-6 wherein the proposed action comprises a purchase order having a modified quantity.

### Example 8

The method of example 7 wherein a key performance indicator comprises inventory projections corresponding to a component in the purchase order.

### Example 9

The method of any of examples 1-8 wherein the key performance indicator comprises multiple key performance indicators and wherein the in memory database performs analytics using the replicated data to generate the updated key performance indicators.

### Example 10

A system comprising:

a simulation manager to receive data corresponding to a proposed action in an application coupled to an application database that stores data corresponding to the application;

a replication agent to merge data corresponding to previously stored application actions with the data corresponding to the proposed action to create a replicated image on an in memory database; and

an analytics engine coupled to semiconductor based database storage to update a key performance indicator based on the replicated image without storing the data corresponding to the proposed action in the application database.

### Example 11

The system of example 10 and further comprising a session manager and side panel to display the updated key performance indicator.

### Example 12

The system of any of examples 10-11 and further comprising an application context to provide the data corresponding to the proposed action and to provide the data corresponding to previously stored actions.

### Example 13

The system of any of examples 10-12 wherein the proposed action includes multiple new actions, each action having multiple parameters.

### Example 14

The system of any of examples 10-13 wherein the key performance indicator comprises multiple key performance indicators and wherein the analytics engine coupled to semiconductor based database storage comprises an in memory database adapted to perform analytics using the replicated data to generate the updated key performance indicators.

### Example 15

A computer readable storage device having instructions to cause a computer to perform a method, the method comprising:

receiving data corresponding to a proposed action in an application coupled to an application database that stores data corresponding to the application;

merging data corresponding to previously stored application actions with the data corresponding to the proposed action to create a replicated image on an in memory database; and

updating a key performance indicator based on the replicated image without storing the data corresponding to the proposed action in the application database.

### Example 16

The computer readable storage device of example 15 wherein the proposed action corresponds to actions available via the application.

### Example 17

The computer readable storage device of example 16 wherein the proposed action includes changes to a previously stored action and wherein the proposed action includes multiple new actions, each action having multiple parameters.

### Example 18

The computer readable storage device of any of examples 16-17 wherein the proposed action comprises a purchase order having a modified quantity.

### Example 19

The computer readable storage device of example 18 wherein a key performance indicator comprises inventory projections corresponding to a component in the purchase order.

### Example 20

The computer readable storage device of any of examples 15-19 wherein the key performance indicator comprises multiple key performance indicators and wherein the in memory database performs analytics using the replicated data to generate the updated key performance indicators.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving data corresponding to a proposed action in an application coupled to an application database that stores data corresponding to the application;
merging data corresponding to previously stored application actions with the data corresponding to the proposed action to create a replicated image on an in memory database; and
updating a key performance indicator based on the replicated image without storing the data corresponding to the proposed action in the application database.

2. The method of claim 1 and further comprising displaying the updated key performance indicator.

3. The method of claim 2 and further comprising storing the proposed action based on the key performance indicator.

4. The method of claim 1 wherein the proposed action corresponds to actions available via the application.

5. The method of claim 4 wherein the proposed action includes changes to a previously stored action.

6. The method of claim 4 wherein the proposed action includes multiple new actions, each action having multiple parameters.

7. The method of claim 4 wherein the proposed action comprises a purchase order having a modified quantity.

8. The method of claim 7 wherein a key performance indicator comprises inventory projections corresponding to a component in the purchase order.

9. The method of claim 1 wherein the key performance indicator comprises multiple key performance indicators and wherein the in memory database performs analytics using the replicated data to generate the updated key performance indicators.

10. A system comprising:
a simulation manager to receive data corresponding to a proposed action in an application coupled to an application database that stores data corresponding to the application;
a replication agent to merge data corresponding to previously stored application actions with the data corresponding to the proposed action to create a replicated image on an in memory database; and
an analytics engine coupled to semiconductor based database storage to update a key performance indicator based on the replicated image without storing the data corresponding to the proposed action in the application database.

11. The system of claim 10 and further comprising a session manager and side panel to display the updated key performance indicator.

12. The system of claim 10 and further comprising an application context to provide the data corresponding to the proposed action and to provide the data corresponding to previously stored actions.

13. The system of claim 10 wherein the proposed action includes multiple new actions, each action having multiple parameters.

14. The system of claim 10 wherein the key performance indicator comprises multiple key performance indicators and wherein the analytics engine coupled to semiconductor based database storage comprises an in memory database adapted to perform analytics using the replicated data to generate the updated key performance indicators.

15. A computer readable storage device having instructions to cause a computer to perform a method, the method comprising:
receiving data corresponding to a proposed action in an application coupled to an application database that stores data corresponding to the application;
merging data corresponding to previously stored application actions with the data corresponding to the proposed action to create a replicated image on an in memory database; and
updating a key performance indicator based on the replicated image without storing the data corresponding to the proposed action in the application database.

16. The computer readable storage device of claim 15 wherein the proposed action corresponds to actions available via the application.

17. The computer readable storage device of claim 16 wherein the proposed action includes changes to a previously stored action and wherein the proposed action includes multiple new actions, each action having multiple parameters.

18. The computer readable storage device of claim 16 wherein the proposed action comprises a purchase order having a modified quantity.

19. The computer readable storage device of claim 18 wherein a key performance indicator comprises inventory projections corresponding to a component in the purchase order.

20. The computer readable storage device of claim 15 wherein the key performance indicator comprises multiple key performance indicators and wherein the in memory database performs analytics using the replicated data to generate the updated key performance indicators.
